(19) United States
(12) Patent Application Publication
(10) Pub. No.: US 2016/0102373 A1
(43) Pub. Date: Apr. 14, 2016

(54) PELT BOARD

(71) Applicant: 4M GLOBE MANAGEMENT LTD., London (GB)

(72) Inventor: Kurt Pedersen, Vinderup (DK)

(21) Appl. No.: 14/892,557

(22) PCT Filed: May 15, 2014
(86) PCT No.: PCT/EP2014/059936

§ 371 Date: Nov. 19, 2015

(30) Foreign Application Priority Data
May 23, 2013 (DK) PA 2013 70278

(51) Int. Cl. C14B 15/06

(52) U.S. Cl. CPC C14B 15/06

(57) ABSTRACT

A pelt board (11) is disclosed for stretching and drying of tubular pelts (5), the pelt board (11) having a tip end (4) from which the pelt is drawn onto the pelt board (11) and a foot end (2), wherein the pelt board (11) has a lower part (8) nearest the foot end (2) where the outer cross-sectional circumference of the pelt board (11) is substantially constant and an upper part (9) between the lower part (8) and the tip end (4), where the outer cross-sectional circumference of the upper part (9) gradually decreases towards the tip end (4), wherein the longitudinal extent (L1) of the lower part (8) is in the range of 36 to 50 cm, more preferably in the range of 40 to 45 cm. Furthermore is disclosed an extension piece for connecting with a standard pelt board and fat-absorbing inner bags (13, 19) for use with the pelt board (11).

The present invention relates to a pelt board for stretching and drying of tubular pelts from fur animals, in particular from mink such as pelts of male mink. It furthermore relates to an inner bag for such pelt board as well as to the use of the pelt board.

### BACKGROUND

Frames on which pelts can be stretched and dried after pelting of the fur animals are well known in the art, ranging from a simple flat and solid wooden slat to more sophisticated pelt boards (or pelting boards) in wood or plastic material.

The overall shape of the known pelt boards are generally of a tapering or conical shape, pelt boards for male animal pelts are often provided with a short part of a constant cross-sectional circumference at the foot end of the pelt board where the tail end of the pelt is supposed to be arranged.

U.S. Pat. No. 3,313,038 discloses a pelt drying frame in plastic or non-absorbent material and wood which as an open internal structure that allows for drying air to be supplied to the cavity defined by the frame and the tubular pelt in order to enhance the drying of the pelt. The frame also contains an arrangement for stretching of the tubular pelt in the longitudinal direction thereof.

Another pelting board is disclosed in WO 82/03634, which is manufactured in a non-absorbent plastic and comprises a lattice of girders between the edges of the pelting board for improving the airflow of drying air inside the pelting board.

A problem for the aforementioned types of pelt boards is that the tubular pelt shrinks during the drying process and will exert a squeezing force on the pelt board. Thus, the dried pelt may be difficult to remove from the pelt board and in a few case it is necessary to cut the pelt open to be able to remove it from the pelt board.

An alternative arrangement for drying of tubular pelts is disclosed in U.S. Pat. No. 3,137,963 and in U.S. Pat. No. 3,271981 comprises a frame with two legs that are pivotally connected at one end, which is inserted into the tubular pelt to be dried, and a lever at the opposite end which is used to force the two legs from each other and ensure that the pelt is taut on the frame when drying. When the pelt is sufficiently dry, the lever is turned and the legs are allowed to pivot and collapse the frame for easy removal of the dried pelt. The pelt is during the drying only supported by the two legs for promoting the circulation of air on the inside of the pelt. However, it is today preferred to dry the pelts on an actual pelt board that support the inner surface of the tubular pelt during the drying process.

The pelt board disclosed in WO 2005/026394 has a general tapering shape towards a tip end of the pelt board from which the pelt is to be arranged on and removed from the pelt board after drying, so as to facilitate the removal of the dried pelt. Furthermore, in order to facilitate a more efficient removal of the dried pelt from the pelt board is comprises two half parts that are forced from each other and locked in a position, where the circumference is larger and slot-shaped openings are formed between the edges of the half parts and where the pelt is drawn upon the pelt board for drying thereof, and the pelt board may when the pelt is dried be shifted to a second position where the edges of the two half parts abut and the circumference consequently is smaller and the pelt may be removed more easily.

The standard pelt board for drying pelts of male mink is today a 120 cm long pelt board where the approximately 90 cm long upper part from a tip end, from which the pelt is drawn onto the pelt board, is of a tapering shape with a substantially oval cross-sectional shape and the approximately 30 cm long lower part, which is also of a substantially oval cross-sectional shape, has a constant cross-sectional outer circumference of about 250 mm. The overall size of animal pelts, in particular of mink pelts, is increasing due to selective breeding of the animals in order to obtain larger pelts and it is a main object of the present invention to provide a pelt board for accommodating this development.

### BRIEF DESCRIPTION OF THE PRESENT INVENTION

The present invention relates to a pelt board for stretching and drying of tubular pelts, in particular for pelts of male mink, the pelt board having a tip end from which the pelt is drawn onto the pelt board and a foot end, wherein the pelt board has a lower part nearest the foot end where the outer cross-sectional circumference of the pelt board is substantially constant and an upper part between the lower part and the tip end, where the outer cross-sectional circumference of the upper part gradually decreases towards the tip end. The present inventive solution to the problem of the increasing size of pelts is to increase the longitudinal extent of the lower part of the pelt board instead of increasing the longitudinal extent of the conical part.

The known pelt boards for pelts of male mink are of an overall length of 120 cm, where the lower part of a substantially constant cross-sectional circumference has an extent of about 30 cm. The present pelt board is inventive in that the longitudinal extent of the lower part is in the range of 36 to 50 cm, more preferably in the range of 40 to 45 cm. The longitudinal extent of the lower part is preferably either 36 cm or 42 cm, which corresponds to an elongation of the lower part of the standard pelt board by one pelt size (6 cm) or two pelt sizes (12 cm), respectively. The longitudinal extent of the upper, tapering part is however preferably about 90 cm, i.e. the same as for the standard pelt board for pelts of male mink. Thus, the extent of the pelt board from the foot end to the tip end thereof is preferably within the range of 126 to 140 cm, more preferably within the range of 130 to 135 cm. The pelt board according to the present invention deviates from the prior art in that the longitudinal extent of the lower part constitutes more than one quarter of the overall length of the pelt board and no more that 0.35 of the overall length of the pelt board, the lower part constitutes preferably between 0.30 and 0.35 of the overall length of the pelt board.

By operating with an extended lower part, it is possible to design the pelt board according to the present invention for larger sizes of pelt, in particular pelts of male mink, while retaining the shape of the upper part of the pelt board from prior pelt boards, in particular that described above as a standard pelt board for pelts of male mink. Hereby it is achieved that all pelts, longer or shorter, dried on the pelt board according to the present invention may have the same dimensions in the width of the pelt as pelts dried on a standard pelt board and may therefore be graded, valuated, traded and processed further using the same terms, principles and tools as pelts dried on a standard pelt board. Furthermore, in a particular embodiment of the pelt board according to the present invention, the pelt board is made from a standard pelt board and an extension piece mounted at the foot end of the standard pelt board, which is only possible with the pelt board according to the present invention.

When starting from the design of the standard pelt board to accommodate the increase of the pelt size, it has been found by the inventor that the elongation of the lower part of the standard pelt board is in fact providing a pelt board that is operational, i.e. that the pelt is actually possible to mount and in particular to remove from the pelt board when dried although it is the part of the pelt board with the substantially constant cross-sectional circumference that is elongated instead of the tapering upper part, from which it is known that the dried pelt is more easily loosened from for removal of the pelt. However, the pelt board according to the present invention is preferably equipped with expansion means for selectively shifting the pelt board between an expanded position and a non-expanded position in which the outer cross-sectional circumference of the pelt board is reduced as compared to the expanded position for facilitating the removal of the dried pelt from the pelt board.

The pelt board is preferably of a flattened cross-sectional shape, so that the longer dimension of the cross-sectional shape when the expansion means is in an expanded position is at least twice the shorter dimension thereof, such as between 2.5 and 3 times the shorter dimension of the cross-sectional shape over a majority of the longitudinal extent of the pelt board, such as at least 75% of the longitudinal extent of the pelt board. The cross-sectional shape of the pelt board will normally be less flattened near the tip end.

The pelt board is preferably of a symmetrical configuration, i.e. that the board is symmetrical around a first longitudinal plane extending through a centre line of the board and parallel to the broad elongated side surfaces. The pelt board may also be symmetrical around a second longitudinal plane extending through the centre line and being perpendicular to the first plane.

Not only the outer cross-sectional circumference but also the cross-sectional shape of the pelt board is preferably substantially constant throughout the lower part of the pelt board.

The curve along which the cross-sectional circumference is measured is the circumscribed curve around the cross-section of the pelt board and corresponds to the length of the pelt around the cross-section when the pelt is arranged on the pelt board for drying.

The outer cross-sectional circumference of the lower part of the pelt board is preferably in the range of 235 mm to 265 mm, i.e. about the size of the standard pelt board, preferably around 250 mm. The advantage is that the current arrangements e.g. for drying of the pelts by blowing air into the pelt boards, arrangements for treating the fur of the pelts while arranged on the pelt boards, e.g. by water brushing, and arrangements for handling of pelt boards, such as for removal of pelt boards from drying arrangements, for stretching and fastening of pelts on pelt boards and for removal of dried pelts from the pelt boards may be re-used with these novel pelt boards according to the present invention.

The cross-sectional shape of the pelt board is preferably substantially constant throughout the lower part of the pelt board when the expansion means are in the expanded position and also substantially constant when the expansion means are in the non-expanded position.

The pelt board comprises preferably an element projecting from the foot end of the pelt board, the projecting element having an inlet for receiving a flow of air and an air conducting arrangement including openings in an outer surface of the pelt board connected to said inlet for providing a flow of air to a pelt arranged on the pelt board.

The expansion means may in a preferred embodiment be operated by means of the projecting element.

By the term operating is understood that the expansion means are applied to shift the pelt board between the expanded and the non-expanded position. The expansion means may be operated by pulling and/or pushing the projecting element in the longitudinal direction of the pelt board.

The pelt board may as mentioned previously comprise a main piece, such as a standard pelt board, and an extension piece connected with a foot end of the main piece, the main piece comprising a main piece projecting element, which projects from the foot end of the main piece in the longitudinal direction thereof and has an inlet for receiving a flow of air, wherein the extension piece comprises an opening at a first end for receiving said main piece projecting element and a supplementary projecting element extending from the second, opposite end of the extension piece which constitutes the foot end of the pelt board and has an inlet for receiving a flow of air, the extension piece being provided with an internal conduct for allowing a flow of air received from said supplementary projecting element to be conducted to said inlet of the projecting element of the main piece received in said opening of the extension piece.

The longitudinal extent of the main piece is preferably within the range of 116 to 124 cm as measured from the tip end to the foot end of the main piece, and in particular around 120 cm, i.e. the length of the standard pelt board for pelts of male mink.

The longitudinal extent of the extension piece from the first end to the second end thereof is preferably in the range of 6 to 20 cm, more preferably in the range of 10 to 15 cm, preferably either 6 cm or 12 cm, which corresponds to an elongation of the lower part of the standard pelt board by one pelt size (6 cm) or two pelt sizes (12 cm), respectively.

The extension piece may be provided with means for mechanically connecting the supplementary projecting element with a projecting element of the main piece received in said opening of the extension piece, so that the projecting element of the main piece is displaced in the longitudinal direction of the extension piece simultaneously with the supplementary projecting element.

In a particular embodiment, the supplementary projecting element is rigidly connected to the extension piece, so that the projecting element is displaced in the longitudinal direction of the pelt board simultaneously with the extension piece.

The present invention relates in a particular an extension piece suitable for connecting with a foot end of a standard pelt board for stretching and drying of tubular pelts, the standard pelt board comprising an element projecting from the foot end of the standard pelt board in the longitudinal direction thereof and having an inlet for receiving a flow of air, wherein the extension piece comprises an opening at a first end for receiving said projecting element and a supplementary projecting element extending from the second, opposite end of the extension piece and having an inlet for receiving a flow of air, the extension piece being provided with an internal conduct for allowing a flow of air received from said supplementary projecting element to be conducted to said inlet of a projecting element of a standard pelt board received in said opening of the extension piece.

The longitudinal extent of the extension piece from the first end to the second end thereof is preferably in the range of 6 to 20 cm, more preferably in the range of 10 to 15 cm. More preferably, the longitudinal extent is either 6 cm or 12 cm, which corresponds to an elongation of the lower part of the standard pelt board by one pelt size (6 cm) or two pelt sizes (12 cm), respectively.

In a preferred embodiment of the extension piece, the outer cross-sectional circumference of the extension piece is substantially constant along the longitudinal direction of the extension piece. The outer cross-sectional circumference of the extension piece is preferably in the range of 235 mm to 265 mm, such as about 250 mm. The cross-sectional size and shape of the extension piece is preferably equal to the lower part of a standard pelt board onto which the extension piece is supposed to be mounted.

The extension piece is preferably provided with means for mechanically connecting the supplementary projecting element with a projecting element of a standard pelt board received in said opening of the extension piece, so that the projecting element is displaced in the longitudinal direction of the extension piece simultaneously with the supplementary projecting element.

In a simple and preferred embodiment, the extension piece is designed to be connected to the projecting element of the pelt board, e.g. by gluing, and to be displaceable with this, so that the pelt board may be brought to the non-expanded position by displacing the whole extension piece away from the foot end of the pelt board in the longitudinal direction of the pelt board.

The present invention relates in a particular aspect also to the use of a pelt board according to the invention for the stretching and drying of tubular mink pelts.

The present invention relates in yet another aspect to a first embodiment of a tubular inner bag made from a fat-absorbing material for being arranged on a pelt board between said pelt board and a tubular pelt to be stretched and dried, the inner bag having a tip end from which the pelt is drawn onto the inner bag on the pelt board and a foot end, wherein the inner bag has a lower part nearest the foot end where the cross-sectional circumference of the inner bag is substantially constant and an upper part between the lower part and the tip end, where the cross-sectional circumference of the inner bag gradually decreases towards the tip end.

Such design of an inner bag is suited for any pelt board comprising a tapering upper part and a lower part with a substantially constant outer cross-sectional circumference so as to avoid the presence of excessive inner bag material at the lower part of the pelt board as is the case with a traditional inner bag, which is of a frusto-conical shape. The excessive material may cause deformations of the dried pelt caused by the occurrence of longitudinal folds, in particular for a pelt board according to the present invention, where the lower part is elongated as compared to the standard pelt board for pelts of male mink.

The inner bag is preferably dimensioned for use with the pelt board according to the present invention, which more specifically provides the following preferred measures of the inner bag. The longitudinal extent of the lower part of the inner bag is preferably in the range of 8 to 45 cm, more preferably in the range of 15 to 40 cm, such as a minimum of 25 cm. The longitudinal extent of the upper part of the inner bag is preferably in the range of 30 to 100 cm, more preferably in the range of 50 to 90 cm such as in the range of 60 to 80 cm. Also, the outer cross-sectional circumference of the upper part of the inner bag preferably gradually decreases at a rate in the range of 10 to 20%, i.e. the circumference decreases with 10 to 20% of the length of a step in the longitudinal direction of the pelt board. The extent of the inner bag from the foot end to the tip end thereof is preferably within the range of 60 to 145 cm, more preferably within the range of 75 to 125 cm. The cross-sectional circumference of the lower part of the inner bag is preferably in the range of 250 mm to 350 mm.

The present invention relates in yet an aspect to the use of an inner bag as described above according to a first embodiment where the inner bag is provided between a pelt board according to the present invention and the mink pelt, in particular a use, wherein the extent of the lower part of the inner bag is from 5 to 20 cm shorter than the extent of the lower part of the pelt board. Furthermore, it is preferred that the extent of the upper part of the inner bag is from 5 to 30 cm shorter than the extent of the upper part of the pelt board. Also, the present invention relates to a system for stretching and drying of tubular mink pelts comprising a pelt board according to the present invention on which is arranged a tubular inner bag (13, 19) according to the first embodiment of an inner bag.

The present invention relates in yet another aspect to a second embodiment of at tubular inner bag made from a fat-absorbing material for being arranged on a pelt board between said pelt board and a tubular pelt to be stretched and dried, the inner bag having a tip end from which the pelt is drawn onto the inner bag on the pelt board and a foot end, wherein the cross-sectional circumference of the inner bag gradually decreases from the foot end towards the tip end and wherein the inner bag has a lower part between the foot end of the inner bag and the longitudinal position where the cross-sectional circumference of the inner bag is 250 mm, wherein the longitudinal extent of the lower part is in the range of 25 to 45 cm, preferably in the range of 28 to 35 cm. This inner bag is particularly suited for use with a pelt board according to the present invention and an outer cross-sectional circumference of the lower part of about 250 mm as traditional inner bags will be too short to cover the board under the full extent of a long pelt, in particular a male mink pelt, arranged on the pelt board for which reason fat from the lower end of the pelt nearest the foot end of the pelt board would not be absorbed by the traditionally inner bag, which may cause damage to the quality of the dried pelt.

In order to fit to preferred embodiments of the pelt board according to the present invention, is preferred that the inner bag is of a conical shape and also that the outer cross-sectional circumference of the inner bag gradually decreases at a rate in the range of 10 to 20% from the foot end to the tip end thereof. Furthermore, the extent of the inner bag from the foot end to the tip end thereof is preferably within the range of 60 to 145 cm, more preferably within the range of 75 to 125 cm.

The present invention relates in a particular aspect also to the use of the inner bag of the second embodiment with a pelt board according to the present invention, wherein the extent of the lower part of the inner bag is from 5 to 20 cm shorter than the extent of the lower part of the pelt board. Furthermore, it is preferred that the extent of the upper part of the inner bag is from 5 to 30 cm shorter than the extent of the upper part of the pelt board.

In a final aspect of the present invention, it relates to a system for stretching and drying of tubular mink pelts comprising a pelt board according to the present invention on which is arranged a tubular inner bag according to the second embodiment of the inner bag according to the present invention.

### BRIEF DESCRIPTION OF THE DRAWING

The accompanying drawing shows an example of the prior art as well as preferred embodiments of the present invention. The figures of the drawing are as follows:

FIG. 1 is a front view of a pelt board according to the Prior Art,

FIG. 2 shows a pelt board according to the present invention,

FIG. 3 shows a pelt board according to FIG. 2 with an inner bag according to a first embodiment of the present invention arranged thereon,

FIG. 4 shows the pelt board and inner bag of FIG. 3 with a pelt arranged thereon,

FIG. 5 shows a pelt board according to FIG. 2 with an inner bag according to a second embodiment of the present invention arranged thereon,

FIG. 6 shows the lower part of the pelt board of FIG. 2 in a particular embodiment comprising an extension piece, and

FIG. 7 shows the lower part of the pelt board of FIG. 6, where the extension piece is displaced a distance from the main piece of the pelt board.

### DETAILED DESCRIPTION OF EMBODIMENTS

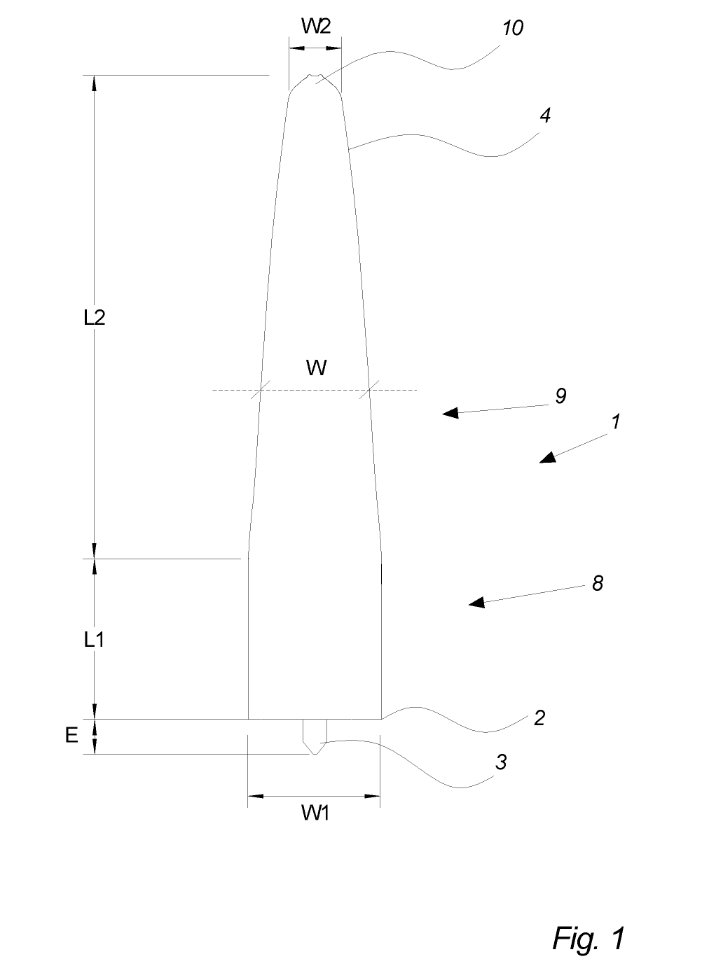

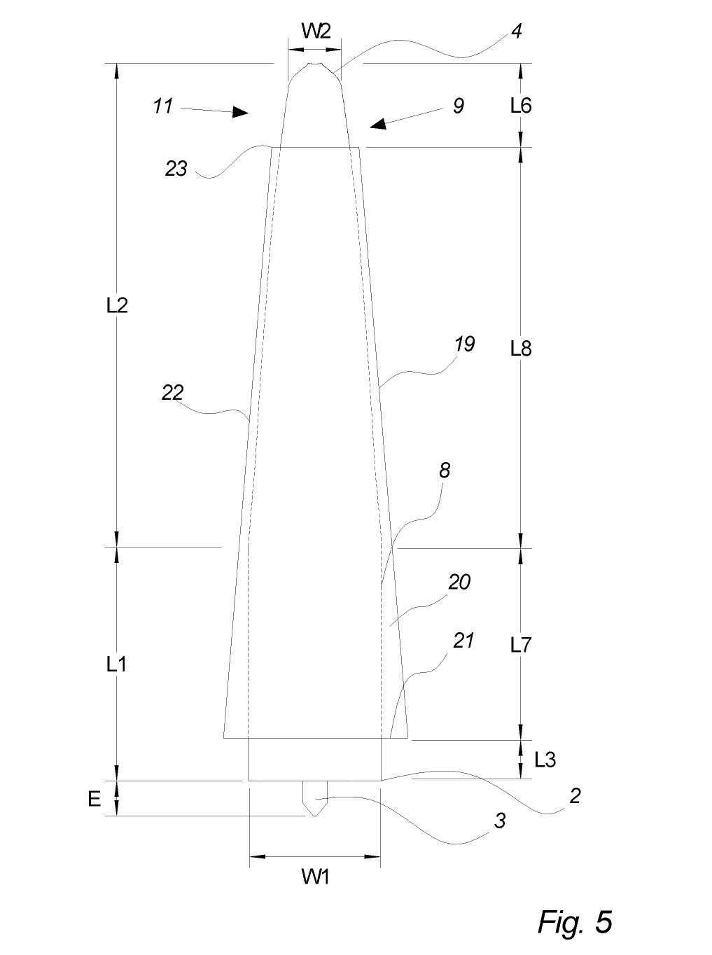

The prior art pelt board 1 shown in FIG. 1 has a foot end 2 from which the projecting element 3 extends and a more narrow tip end 4. The pelt 5 is drawn on the pelt board from the tip end 4, so that the part of the pelt 5 that used to cover the fur animal's cranium 6 rests on the tip end 4 while the tail 7 of the pelt 5 will be situated near the foot end 2 as shown in FIG. 5. The pelt board 1 comprises a lower, straight part 8 with a substantially constant cross-sectional circumference and a constant width W₁ extending from the foot end 2 of the pelt board 1 adjacent to an upper part 9 of the pelt board 1 having a tapering shape where the cross-sectional circumference of the pelt board 1 is gradually reduced from the width W1 of the lower part 8 to the width W2 at the tip end 4 of the pelt board 1. The tapering of the upper part 9 of the pelt board 1 can be linear in the sense that the width W of the upper part 9 varies linearly whereas the thickness remains substantially constant or the cross-sectional circumference of the upper part 9 of the pelt board 1 can decrease linearly with the distance to the lower part 8 of the pelt board 1. Alternatively, the tapering may be non-linear, so that the decrease in width W or in cross-sectional circumference e.g. is less steep near the lower part 8 of the pelt board and increases nearer the tip end 4 of the pelt board. The tip end 4 of the pelt board ends in a tip 10, which normally is of a rounded shape and the width W2 of the tip end 4 is determined at a longitudinal position of the upper part 9 just before such rounding of the tip end 4 of the pelt board 1 occurs. These definitions of lower and upper parts 8, 9, width W1, W2, W and gradually reduction or tapering of the upper part 9 are used in this document for all embodiments of a pelt board.

The prior art pelt board 1 shown in FIG. 1 is intended for being used for stretching and drying of male mink pelts and has a standard length of 120 cm from the foot end 2 to the tip end 4, i.e. that sum of the length L1 of the lower part 8 and the length L2 of the upper part 9 is 120 cm. The length L1 of the lower part is about 30 cm whereas the length L2 of the upper, tapering part 9 is about 90 cm. The width W1 of the lower part 8 of the pelt board 1 is 112 mm and the width W2 of the tip end 4 is 32 mm, and the decrease of the width and thus approximately also of the outer cross-sectional circumference of the upper part of the pelt is of about 70%. The outer cross-sectional circumference of the lower part 8 of the pelt board 1 is about 250 mm. Extending centrally from the foot end 2 of the pelt board 1 is the projecting element 3 which extends in the longitudinal direction of the pelt board 1 and is suited to support the pelt board 1 in an upright position by placing the projecting element 3 in an opening in a horizontal surface of e.g. a drying aggregate with means to force an air flow through the projecting element and into an inlet in the projecting element 3 for receiving a flow of air, which by means of an air conducting arrangement inside the pelt board 1 provides drying air to the inner side of the pelt 5 arranged on the pelt board 1 via a plurality of openings in an outer surface of the pelt board 1. The longitudinal extent E of the projecting element 3 is about 5.5 to 7 cm.

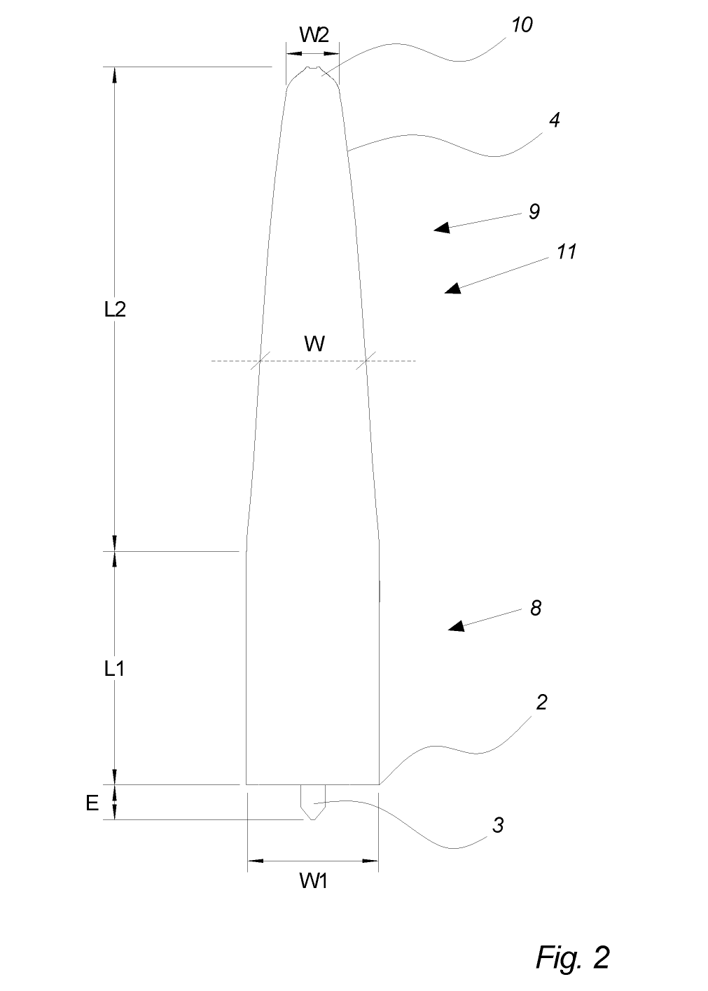

In the pelt board 11 according to the present invention as shown in FIG. 2 the longitudinal extent L2 as well as the shape of the upper, tapering part 9 of the pelt board 11 is the same as for the prior art pelt board 1 of FIG. 1, i.e. that the longitudinal extent L2 is about 90 cm. The longitudinal extent L1 of the lower, straight part 8 with a substantially constant cross-sectional circumference of about 250 mm and a constant width W₁ is about 12 cm longer than that of the prior art pelt board 1, i.e. for the pelt board 11 according to the present invention, the longitudinal extent L1 of the lower part 8 is about 42 cm making the total length L1+L2 of the pelt board 11 according to the present invention about 142 cm. The increase of 12 cm means that the pelt board according to the present invention can accommodate mink pelts of two pelt sizes more than the pelt board of a standard length of 120 cm.

It is generally known in the art to arrange a tubular inner bag 13 made from a fat- and moisture-absorbing material such as paper on the pelt board 1 prior to arranging and stretching the pelt 5 on the pelt board for the purpose of absorbing remaining fat from the skin side of the pelt 5 in order to avoid the fat to stain the fur side of the pelt 5 during or after drying thereof and possibly also to absorb moisture from the skin side of the pelt 5 and give it off to the drying air on the inside of the inner bag 13.

The known pelt boards are of a conical shape which fits to the tapering shape of the pelt board 1 without regard to the lower part of the pelt boards 1 for male mink pelts with a substantially constant outer cross-sectional circumference. Such inner bags are simple to produce from a piece of paper that is cut into shape, folded and glued along a longitudinal line.

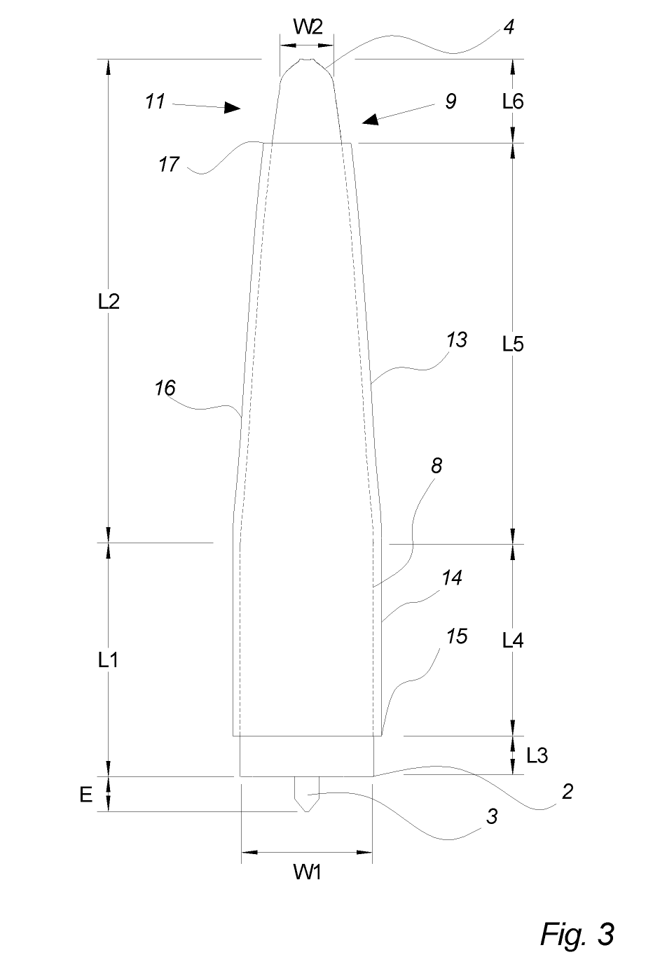

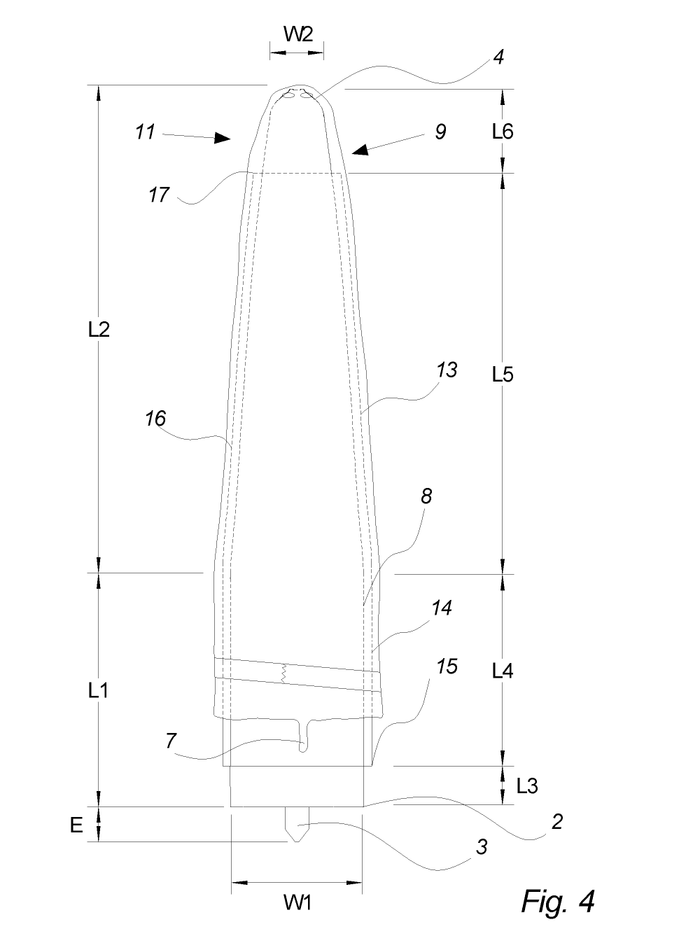

For the pelt boards according to the present invention where the lower part 8 of the pelt board 11 has a substantially longer extent in the longitudinal direction than the traditional pelt board 1, a much longer section of the lower part 8 will be covered by the longer pelt 5 when arranged thereon and consequently should also be covered by the inner bag 13 arranged between the pelt board 11 and the long pelt 5. The traditionally manufactured frusto-conical inner bag is at its foot end wider than the lower part 8 of the traditional pelt board 1 because the lower part 8 has a constant cross-sectional circumference whereas the circumference of the conical inner bag continuously increases towards its foot end. When the lower part of the pelt board is elongated as with the pelt board 11 according to the present invention, the foot end 21 of a conical inner bag 19 with a corresponding elongation, as shown in FIG. 5 illustrating the second embodiment of an inner bag according to the present invention, will be much wider than the lower part 8 of the pelt board 11. In order to reduce the occurrence of longitudinal folds of the lower end 20 of the inner bag 19 when the pelt 5 is stretched and fastened to the pelt board 11, a first embodiment of a new tubular inner bag 13 for being arranged between the pelt board 11 according to the present invention and a pelt 5 has been provided as a part of the present invention as shown in an example in FIGS. 3 and 4 manufactured for and arranged on a pelt board 11 according to the embodiment of the present invention. The tubular inner bag 13 comprises a lower part 14 nearest the foot end 15 of the inner bag 13 where the cross-sectional circumference of the inner bag 13 is substantially constant, in addition to an upper part 16 between the lower part 14 and the tip end 17 of the inner bag, where the cross-sectional circumference of the inner bag 13 gradually decreases towards the tip end 17.

When arranged on the pelt board 11 as shown in FIGS. 3 and 4, it can be seen that the inner bag 13 according to the first embodiment has a length L4 of the lower part 14 that is shorter that the length L1 of the lower part 8 of the pelt board 11, leaving a length L3 of the lower part 8 of the pelt board 11 of e.g. 8 to 14 cm uncovered by the inner bag 13. Likewise, the shown inner bag 13 has a length L5 of the upper part 16 of the inner bag 13 that is shorter than the length L2 of the upper part 9 of the pelt board 12, leaving a length L6 of the upper part 9 uncovered by the inner bag 13, where the length L6 e.g. is in the order of 13 to 24 cm.

In FIG. 4 the pelt board 11 according to the embodiment of the present invention is depicted with the inner bag 13 according to the first embodiment arranged between the pelt board 12 and a pelt 5, which is stretched on the pelt board 11 and fastened by means of a strip 18 of a plastic tape that is wound around the pelt 5 to temporarily fixing the pelt as described in EP 1 723 262. However, the pelt could be fixed by other known means, such as a fixing bag drawn over the pelt arranged on the pelt board or by means of staples that are shot through the part of the pelt 5 near the foot end 2 of the pelt board 11 into a wooden part of the pelt board 11, which however is not a necessary part of the pelt board 11 according to the present invention.

A second embodiment of a tubular inner bag 19 according to the present invention is shown in FIG. 5 as arranged on a pelt board 11 according to the present invention. The inner bag 19 according to the second embodiment is of a conical shape from the tip end 23 to the foot end 21 of the inner bag 19. The lower part 20 of the inner bag 19 is in this embodiment defined to start where the inner cross-sectional circumference of the inner bag 19 is equal to the outer cross-sectional circumference of the lower part 8 of the pelt board 11 according to the present invention, which is about 250 mm. The longitudinal extent L7 of the lower part 20 of the inner bag 19 from said start and to the foot end 21 of the inner bag 19 is shorter that the length L1 of the lower part 8 of the pelt board 11, leaving a length L3 of the lower part 8 of the pelt board 11 of e.g. 8 to 14 cm uncovered by the inner bag 19. Likewise, the shown inner bag 19 has a length L8 of the upper part 22 of the inner bag 19 that is shorter than the length L2 of the upper part 9 of the pelt board 11, leaving a length L6 of the upper part 9 uncovered by the inner bag 19, where the length L6 e.g. is in the order of 13 to 24 cm. Thus, the inner bag 19 according to the second embodiment of the present invention deviates from the traditional inner bag in that the longitudinal extent L7 of the lower part 20 is elongated and is 25 to 45 cm, preferably in the range of 28 to 35 cm.

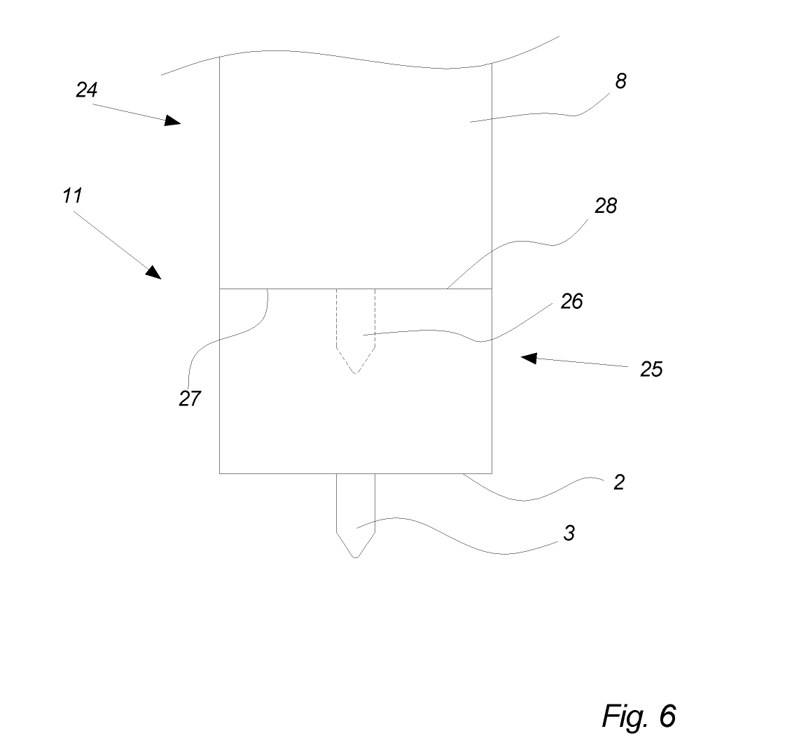

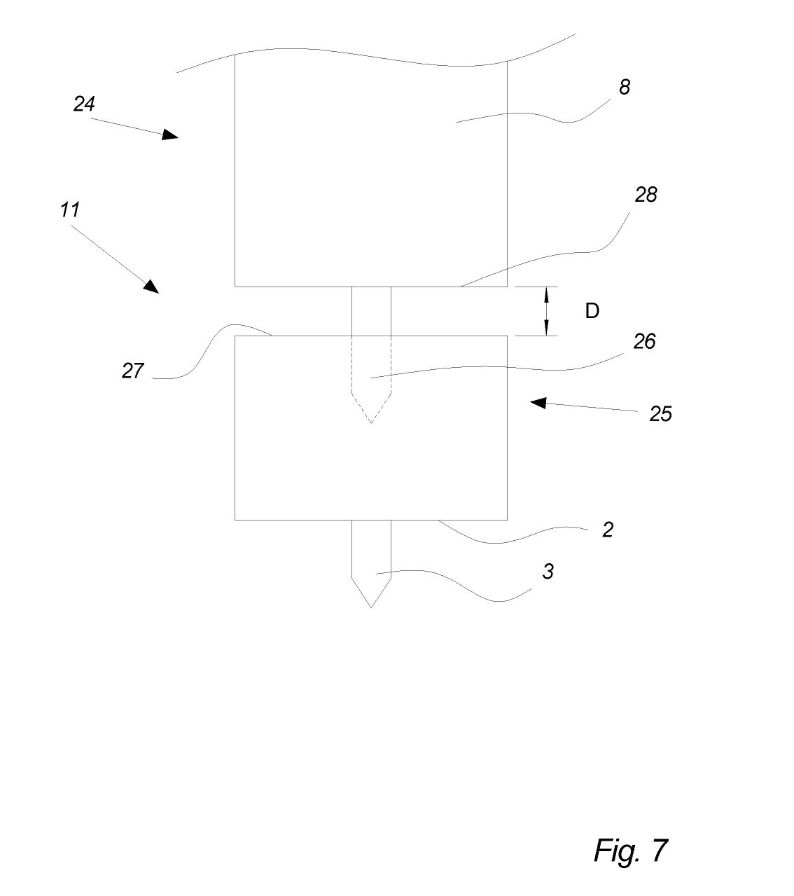

A particular embodiment of the pelt board 11 according to the present invention is shown in FIGS. 6 and 7 where the pelt board 11 comprises a standard known pelt board 24 and an extension piece 25 of a length of typically 12 cm. The standard pelt board 24 is of the type comprising expansion means so that the outer circumference of at least a part of the pelt board 24 can be reduced by displacing the projecting element 26 of the standard pelt board 24 away from the board 24 in the longitudinal direction of the standard pelt board 24 which facilitates the removal of the dried pelt 5 from the pelt board 11. When the projecting element 26 is displaced back towards the board 24 it is again in an expanded position for another pelt 5 to be fastened on the standard pelt board 24. In the shown embodiment, the extension piece 25 is rigidly connected to the projecting element 26 of the standard pelt board 24 so that the upper end 27 of the extension piece 25 abuts the foot end 28 of the standard pelt board 24 when the projecting element 26 of the standard pelt board 24 is in the position, where the standard pelt board is expanded as shown in FIG. 6. The extension piece 25 with the projecting element 3 of the pelt board 11 according to the present invention may be displaced a distance D from the standard pelt board 24 as shown in FIG. 7 so that the outer circumference of the standard pelt board 24 is reduced for the removal of a dried pelt 5 on the pelt board 11 according to the invention. By the provision of the extension piece 25 according to a particular embodiment of the present invention, the pelt board 11 according to the present invention may be produced in a simple and inexpensive manner from such expansion piece 25 and a standard pelt board 11 by e.g. gluing the projecting element 26 of the standard pelt board 24 into an opening (not shown) of the extension piece 25. The extension piece 25 is furthermore provided with an internal conduct (not shown) for directing a flow of air from the projecting element 3 of the extension piece 25 and thus of the pelt board 11 according to the invention and into the projecting element 26 of the standard pelt board 24 for the drying of a pelt 5 arranged on the pelt board 11 according to the present invention.

The pelt board 11 according to the present invention is preferably provided with a plurality of longitudinal grooves in the surface of the pelt board 11 so as to allow drying air to flow from an inner cavity of the pelt board 11 and out through openings in the surface and along the pelt board 11 in the longitudinal grooves between the outer surface of the pelt board 11 and the tubular inner bag 13, 19 where the inner bag 13, 19 will absorb moisture from the skin side of the tubular pelt 5 and deliver it to the air passing in the grooves. The grooves extend preferably to the foot end 2 of the pelt board 11, including in the surface of a possible extension piece 25.

The pelt board 11 is furthermore preferably provided with a holding area defined in the outer surface as an area that is particularly rough, such as having transverse grooves or dents in the ridges between longitudinal grooves, so that holding means applied to the outside of the pelt 5, such as a strip 18 of plastic material or an elastic sleeve drawn over the tip end 4 of the pelt board will force the inner bag 13, 19 into engagement with the holding area, which will increase the friction between the inner bag 13, 19 and the surface of the pelt board 11 and thus secure the position of the pelt 5 on the pelt board 11, in particularly when the pelt 5 dries and shrinks.

### LIST OF REFERENCE NUMERALS

1 Pelt board according to prior art

2 Foot end of pelt board

3 Projecting element

4 Tip end of pelt board

5 Pelt

6 Part of the pelt that used to cover the fur animal's cranium

7 Tail of the pelt

8 Lower part of pelt board

9 Upper tapering part of pelt board

10 Tip of pelt board

11 Pelt board according to the invention

13 Tubular inner bag of first embodiment

14 Lower part of inner bag of first embodiment

15 Foot end of inner bag of first embodiment

16 Upper part of inner bag of first embodiment

17 Tip end of inner bag of first embodiment

18 Strip of plastic material

19 Tubular inner bag of second embodiment

20 Lower part of inner bag of second embodiment

21 Foot end of inner bag of second embodiment

22 Upper part of inner bag of second embodiment

23 Tip end of inner bag of second embodiment

24 Standard pelt board

25 Extension piece

26 Projecting element of standard pelt board

27 Upper end of extension piece

28 Foot end of standard pelt board

L1 Longitudinal extent of lower part of pelt board

L2 Longitudinal extent of upper part of pelt board

L3 Length from foot end of inner bag to foot end of pelt board

L4 Longitudinal extent of lower part of first embodiment of inner bag

L5 Longitudinal extent of upper part of first embodiment of inner bag

L6 Length from tip end of inner bag to tip end of pelt board

L7 Longitudinal extent of lower part of second embodiment of inner bag

L8 Longitudinal extent of upper part of second embodiment of inner bag

W1 Width of lower part of the pelt board

W2 Width of the tip end of the pelt board

W Width of the upper tapering part of the pelt board

D Distance between standard pelt board and extension piece

E Longitudinal extent of projecting element

1. A pelt board for stretching and drying of tubular pelts of male mink, the pelt board comprising a tip end from which the pelt is drawn onto the pelt board and a foot end,
wherein the pelt board has a lower part nearest the foot end where the outer cross-sectional circumference of the pelt board is substantially constant and an upper part between the lower part and the tip end, where the outer cross-sectional circumference of the upper part gradually decreases towards the tip end, and
wherein the longitudinal extent of the lower part is in the range of 36 to 50 cm, more preferably in the range of 40 to 45 cm.

2. The pelt board according to claim 1, wherein the longitudinal extent of the lower part constitutes more than 0.25 and no more than 0.35 of the overall extent of the pelt board.

3. The pelt board according to claim 1, wherein the longitudinal extent of the upper part of the pelt board is about 90 cm.

4. The pelt board according to claim 1, wherein the longitudinal extent of the pelt board from the foot end to the tip end thereof is within the range of 126 to 140 cm, preferably within the range of 130 to 135 cm.

5. The pelt board according to claim 1, wherein the outer cross-sectional circumference of the lower part of the pelt board is in the range of 235 mm to 265 mm.

6. The pelt board according to claim 1, comprising expansion means for selectively shifting the pelt board between an expanded position and a non-expanded position in which the outer cross-sectional circumference of the pelt board is reduced as compared to the expanded position.

7. The pelt board according to claim 1 further comprising an element projecting from the foot end of the pelt board, the projecting element having an inlet for receiving a flow of air and an air conducting arrangement including openings in an outer surface of the pelt board connected to said inlet for providing a flow of air to a pelt arranged on the pelt board.

8. The pelt board according to claim 7, wherein the expansion means may be operated by means of displacing the projecting element in the longitudinal direction of the pelt board.

9-17. (canceled)

18. The method according to claim 33 further comprising:
arranging a tubular inner bag made from a fat-absorbing material between said pelt board and the tubular pelt to be stretched and dried,
arranging the inner bag having a tip end, from which the pelt is drawn onto the inner bag, on the pelt board and a foot end,
wherein the inner bag has a lower part nearest the foot end where the cross-sectional circumference of the inner bag is substantially constant and an upper part between the lower part and the tip end, where the cross-sectional circumference of the inner bag gradually decreases towards the tip end.

19. The method according to claim 18, wherein the longitudinal extent of the lower part is in the range of 8 to 45 cm, preferably in the range of 15 to 40 cm.

20. The method according claim 18, wherein the longitudinal extent of the upper part of the inner bag is in the range of 30 to 100 cm, preferably in the range of 50 to 90 cm such as in the range of 60 to 80 cm.

21. The method according to claim 18, wherein outer cross-sectional circumference of the upper part of the inner bag gradually decreases at a rate in the range of 10 to 20%.

22. The method according to claim 18, wherein the extent of the inner bag from the foot end to the tip end thereof is within the range of 60 to 145 cm, preferably within the range of 75 to 125 cm.

23. The method according to claim 18, wherein the cross-sectional circumference of the lower part of the inner bag is in the range of 250 mm to 350 mm.

24-29. (canceled)

30. The method according to claim 18, wherein the extent of the lower part of the inner bag is from 5 to 20 cm shorter than the extent of the lower part of the pelt board.

31. The method according to claim 18, wherein the extent of the upper part of the inner bag is from 5 to 30 cm shorter than the extent of the upper part of the pelt board.

32. (canceled)

33. A method for stretching and drying tubular pelts of male mink comprising:
providing the pelt board according to claim 1, and
providing a tubular pelt.

34. The pelt board according to claim 2, wherein the longitudinal extent of the upper part of the pelt board is about 90 cm.

35. The method according claim 19, wherein the longitudinal extent of the upper part of the inner bag is in the range of 30 to 100 cm, preferably in the range of 50 to 90 cm such as in the range of 60 to 80 cm.
